(19) United States
(12) Patent Application Publication
(10) Pub. No.: US 2007/0186919 A1
(43) Pub. Date: Aug. 16, 2007

(54) Support device

(76) Inventor: Glen Stuhlmacher II, San Ramon, CA (US)

Correspondence Address: Glen Stuhlmacher II, 45 Cuenca Court, San Ramon, CA, 94583, US

(21) Appl. No.: 11/342,153

(22) Filed: Jan. 27, 2006

(51) Int. Cl. F24B 3/00; A47J 37/00

(52) U.S. Cl. 126/25 R

(57) ABSTRACT

The present invention provides a support device for a barbeque lid comprising a base portion with means for attaching the base portion to a kettle. The support device includes an extension member having one end connected to the base portion and a distal end connected to the other end of the extension member with means for supporting the barbeque lid. The support device is useful during inclement weather.

### BACKGROUND OF THE INVENTION

Barbecue grills are very widely used today. Presently, one of the most popular grills, a kettle-type grill, is being marketed by Weber-Stephen Products Co. This barbecue grill consists of a generally semi-spherical bottom bowl having a circular open top with a cooking grid slightly below the upper rim of the bowl. A fuel support grid for charcoal is positioned below the cooking grid. A generally semi-ellipsoid top cover can be placed on the bottom bowl. The barbecue grill is generally constructed in accordance with the teachings of U.S. Pat. No. Re. 33,091. The grill can be supported by a tripod leg arrangement of the type disclosed in U.S. Pat. No. 3,538,906. The kettle configuration with and without the legs are registered trademarks of the Assignee of the present invention. The kettle can also be supported on various carts, such as those disclosed in U.S. Pat. Nos. 5,027,788 and 5,076,252, also owned by Weber-Stephen Products Co.

Steaks, hamburgers and hotdogs among the most popular barbeque items, are best cooked over an open flame. Placing a lid over these items will usually has a negative effect on the taste and texture of the meat.

One shortcoming of the kettle-type grill design is its effectiveness during inclement weather. Inclement weather can arrive without notice. Elevating the lid allows the popular method of open flame grilling while protecting the food and charcoal from the inclement weather. Elevating the lid allows the protection needed to ignite the charcoal in inclement weather. There is a need in the art for lid holders for inclement type weather. The present invention satisfy these and other needs.

### SUMMARY OF THE INVENTION

During inclement weather, such as rain and snow showers, it would be advantageous to cook or BBQ while the lid of the kettle of the grill remain covering the cook surface. The present invention keeps the cook-top of the grill out of the elements. As such, the present invention provides a support device for a barbeque lid, comprising:

a base portion with means for attaching the base portion to a kettle;

an extension member having one end connected to the base portion; and

a distal end connected to the other end of the extension member with means for supporting the barbeque lid.

In certain aspects, the means for attaching the base portion is removably attached to the kettle.

In another aspect, the present invention provides a support device for a barbeque lid, comprising:

a base portion with a clamp for attaching the base portion to a kettle;

an extension member having one end connected to the base portion; and

a distal end connected to the other end of the extension member with a V support for supporting the barbeque lid.

These and other objects, advantages and embodiments will become more apparent when read with the accompanying figures and detained description.

### BRIEF DESCRIPTION OF THE DRAWINGS

FIG. 1 is a perspective view of the charcoal grill.

FIG. 2 shows a perspective view of three support devices of the present invention.

FIG. 3 shows is a perspective view of the charcoal grill with three support devices of the present invention.

FIG. 4 shows is a perspective view of a support devices of the present invention.

### DETAILED DESCRIPTION OF THE INVENTION

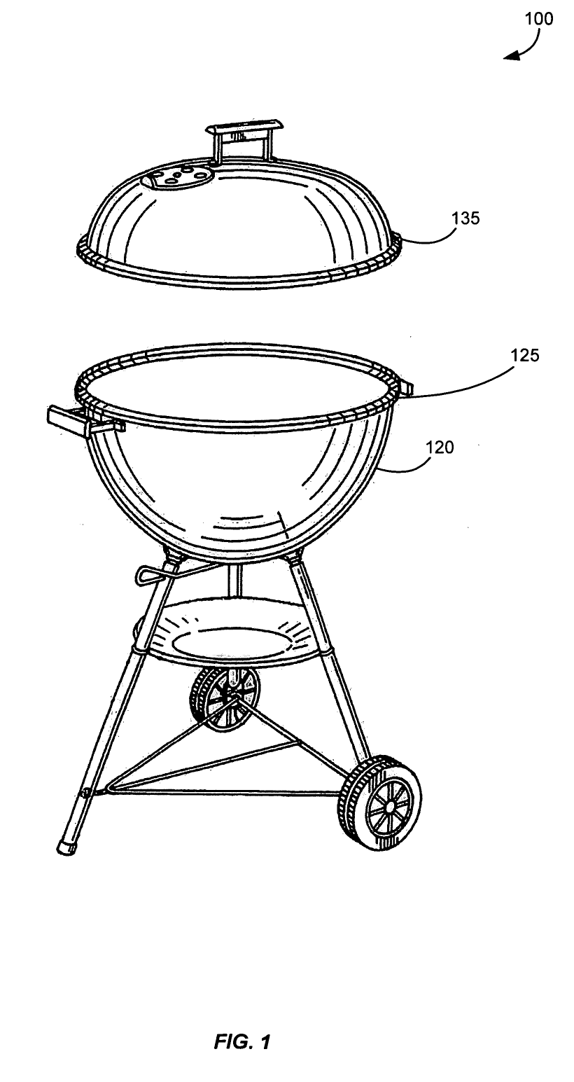

With reference to FIG. 1, the barbecue grill 100 consists of a generally semi-spherical bottom bowl 120 having a circular open top 125 with a cooking grid fitted below the upper rim of the bowl. A generally semi-ellipsoid top cover 135 can be placed on the bottom bowl 120.

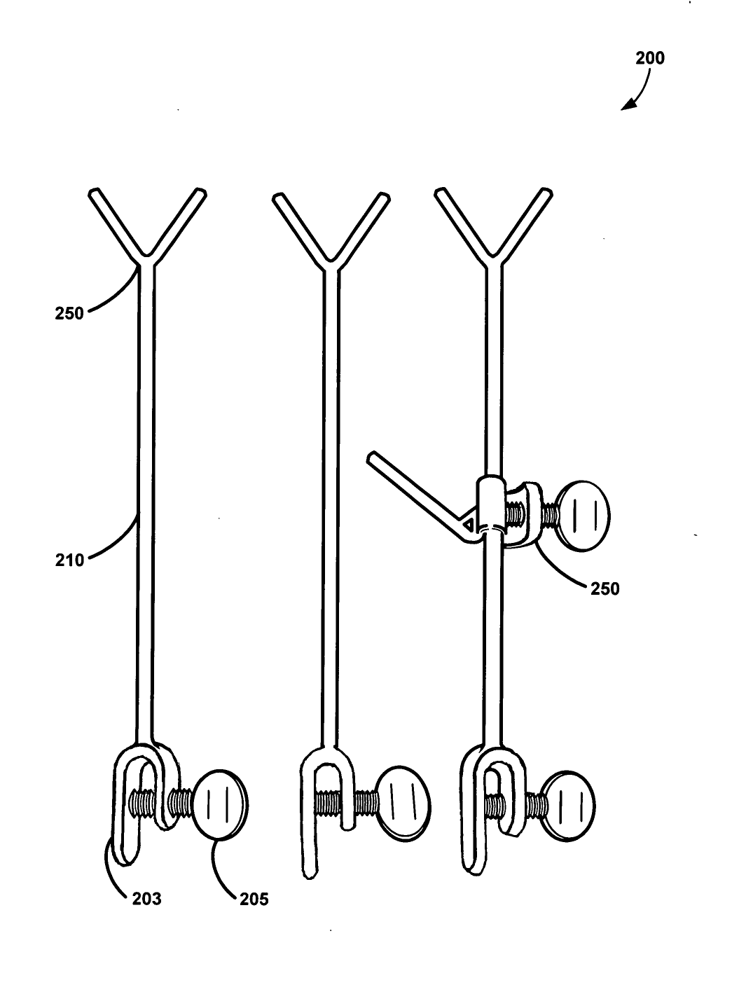

FIG. 2 shows one embodiment of the present invention. As shown therein, a support device for a barbeque lid comprising a base portion 203 with means 205 for attaching the base portion 203 to a kettle. An extension member 210 having one end connected to the base portion 203. The support device also has a distal end 250 connected to the other end of the extension member 210 with means for supporting the barbeque lid. In certain aspects, the means for attaching the base portion is removably attached to the kettle. In certain other aspects, the means for supporting the barbeque lid is removably attached to the lid.

Various means for attaching the base portion to the kettle include a clamp type, a screw type, a spring type, a thread type, a magnet type, a latch type, a lever type and a ring type. In certain aspects, the support is screwed into the lid and rests on the kettle. In this manner, a support, preferably at least two supports are screwed into the lid. Those of skill in the art will know of other configurations of the means for attaching the base portion to the kettle.

Various means for supporting the barbeque lid include, but are not limited to, a V type, a clamp type, a screw type, a spring type, a magnet type, a latch type, a lever type and a ring type. Those of skill in the art will know of other configurations of the means for supporting the barbeque lid.

The extension member 210 has one end connected to the base portion 203 and the other end connected to the means for supporting the lid. In certain aspects, the extension member has a fixed length. In one aspect, the extension member is between about 1 inch and about 24 inches in length. Preferably, the extension member is about 5 to about 18 inches in length. In another aspect, the extension member has an adjustable length, such as being telescopically adjustable.

As shown in FIG. 2, in certain aspects, the support device further comprises a second means 250 for supporting the barbeque lid. This can be an auxiliary means for keeping wind and the like, away from the fire. The second adjustable means for supporting the barbeque include, but are not limited to a V type, a clamp type, a screw type, a spring type, a magnet type, a latch type, a lever type and a ring type. In one aspect, the second means for supporting the barbeque lid is removable. In certain other instances, the extension member can slide through the means for attaching the base portion to the kettle, allowing the lid to easily shut onto the kettle. In yet another aspect, the extension member can hinge outwardly, allowing the lid to close. All such embodiments are within the scope of the present invention.

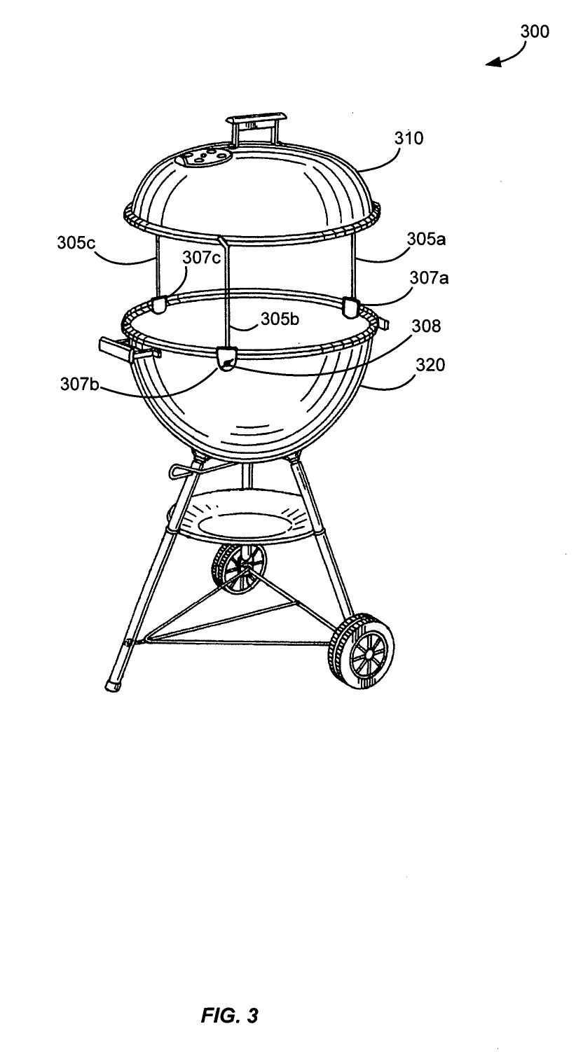

FIG. 3 is a perspective view of the charcoal grill 300 having the 3 support devices of the present invention incorporated therein. The barbecue grill 300 consists of a generally semi-spherical bottom bowl 320 having a circular open top with a cooking grid fitted below the upper rim of the bowl. A generally semi-ellipsoid top cover 310 can be placed on the bottom bowl 320. Three support devices 305a 305b, and 305c keep the top cover 310 over the cooking surface. Each of the support devices has a base portion 307a, 307b and 307c with means such as screw 308 for attaching the base portion to a kettle.

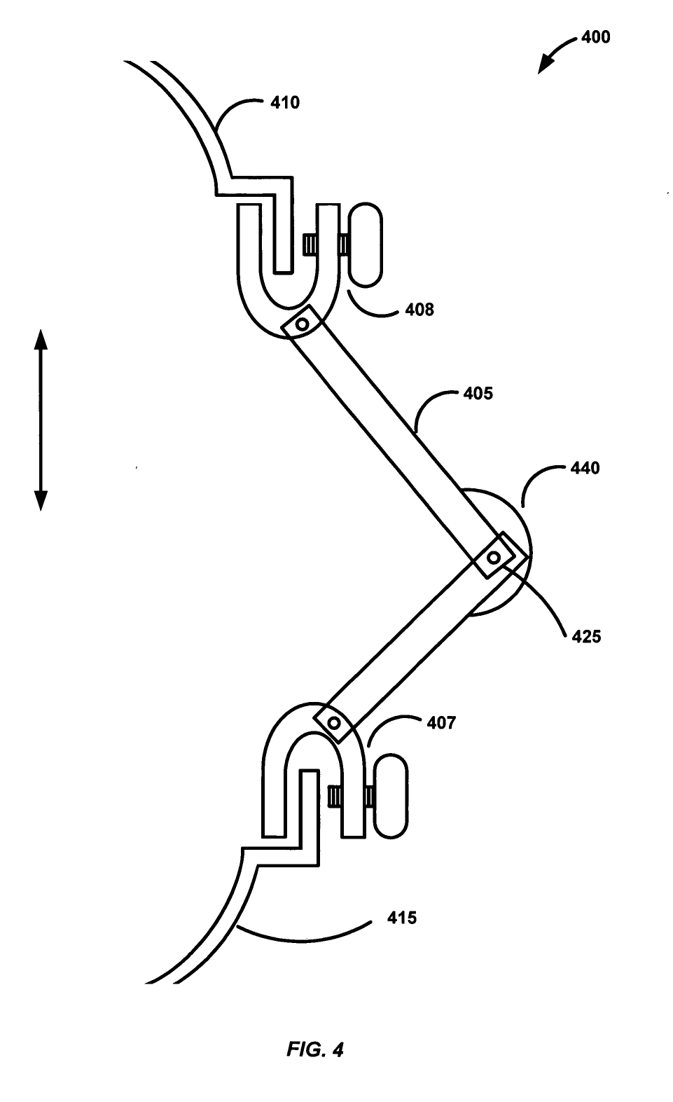

FIG. 4 is a perspective of another embodiment of a support device of the present invention. In this aspect, the extension member 405 has one end connected to the base portion 407 and the other end connected to the means 408 for supporting the lid 410. In certain aspects, the extension member 405 is retractable and bendable at a elbow 425. In one aspect, the elbow 425 of the extension member 405 bends to allow the lid 410 to close onto the kettle. Preferably, the extension member 405 is bendable via a spring means 440. Those of skill in the art will know of other means to allow the extension member to bend.

In certain aspects, the present invention provides a kit with a plurality of support devices therein, such as at least 1 support, at least 2 supports, at least three supports, at least 4 supports, and the like. The kit optionally includes instructions for use, such as attachment to the BBQ.

What is claimed is:

1. A support device for a barbeque lid, said support device comprising:
a base portion with means for attaching said base portion to a kettle;
an extension member having one end connected to said base portion; and
a distal end connected to the other end of said extension member with means for supporting said barbeque lid.

2. The support device for a barbeque lid of claim 1, wherein said means for attaching said base portion is removably attached to said kettle.

3. The support device for a barbeque lid of claim 1, wherein the means for supporting said barbeque lid is removably attached to said lid.

4. The support device for a barbeque lid of claim 2, wherein said means for attaching said base portion to said kettle is selected from the group consisting of a clamp type, a screw type, a spring type, a thread type, a magnet type, a latch type, a lever type and a ring type.

5. The support device for a barbeque lid of claim 1, wherein said means for attaching said base portion to said kettle is a clamp type.

6. The support device for a barbeque lid of claim 1, wherein said means for attaching said base portion to said kettle is a screw type.

7. The support device for a barbeque lid of claim 1, wherein said means for supporting said barbeque lid is selected from the group consisting of a V type, a clamp type, a screw type, a spring type, a magnet type, a latch type, a lever type and a ring type.

8. The support device for a barbeque lid of claim 7, wherein said means for supporting said barbeque lid is a V type.

9. The support device for a barbeque lid of claim 1, wherein said extension member has a fixed length.

10. The support device for a barbeque lid of claim 1, wherein said extension member has an adjustable length.

11. The support device for a barbeque lid of claim 10, wherein the length of said extension member is telescopically adjustable.

12. The support device for a barbeque lid of claim 1, wherein said extension member is between about 1 inch and about 20 inches in length.

13. The support device for a barbeque lid of claim 1, wherein said support means is adjustable between the distance of said base portion and said distal end.

14. The support device for a barbeque lid of claim 1, further comprising a second means for supporting said barbeque lid.

15. The support device for a barbeque lid of claim 14, wherein said second means for supporting said barbeque lid is selected from the group consisting of a V type, a clamp type, a screw type, a spring type, a magnet type, a latch type, a lever type and a ring type.

16. The support device for a barbeque lid of claim 14, wherein said second means for supporting said barbeque lid is removable.

17. A support device for a barbeque lid, said support device comprising:
a base portion with a clamp for attaching said base portion to a kettle;
an extension member having one end connected to said base portion; and
a distal end connected to the other end of said extension member with a V support for supporting said barbeque lid.
